(19) United States
(12) Patent Application Publication
(10) Pub. No.: US 2020/0347669 A1
(43) Pub. Date: Nov. 5, 2020

(54) Pet Door Security System

(71) Applicants: Lee W. Nickerson, Phoenix, AZ (US); Lisa Nickerson, Phoenix, AZ (US)

(72) Inventors: Lee W. Nickerson, Phoenix, AZ (US); Lisa Nickerson, Phoenix, AZ (US)

(21) Appl. No.: 16/400,728

(22) Filed: May 1, 2019

(51) Int. Cl. E06B 7/32

(52) U.S. Cl. CPC E06B 7/32

(57) ABSTRACT

A system having means for providing secured access to a new or existing pet door; means for mounting the secured access providing means about a perimeter of the new or existing pet door; means for engaging the secured access mounting means and the secured access providing means; means for selectively preventing unwanted access through the secured access providing means; means for receiving the unwanted access preventing means; means for installing the mounting means to the new or existing pet door; means for preventing an intruder from prying open the unwanted access preventing means; and means for operating the unwanted access preventing means.

### CROSS-REFERENCE TO RELATED APPLICATIONS

Not applicable.

### RELATED CO-PENDING U.S. PATENT APPLICATIONS

Not applicable.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to door systems. More particularly, certain embodiments of the invention relate to pet door systems.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Pets provide companionship, friendship, comfort and comradery. At the same token, pets may also impose risks to the security of a household. Pet doors that are so commonly featured as convenience items in pet-owning households may become entry points for burglary and vandalism. The so-called “security” versions available today may not prevent those crimes, either, and could even pose new risks to the pets themselves. Many folks assume that having a pet will help prevent burglaries; the bark of a dog would scare away the wrongdoers. That's far from the truth, however. In fact, pet ownership may make a home more at risk for burglary. These burglaries most often take place between 10 a.m. and 3 p.m., when the parents are at work and the kids are at school. No one's at home except for the animals, so burglaries are much more likely to occur. In that same time period, and to prevent any “animal accidents” inside the house, pets are often kept in the backyard or restricted to a particular room. The animals aren't exactly protecting the home as a result. The burglars know these traits, too. Additionally, burglars commonly reside within two miles of the homes they break into. They're quite familiar with those houses, as well. Due to that familiarity, even alarms don't prevent burglaries. Their knowledge of the homes and neighborhoods allows burglars to complete the jobs in less than 10 minutes—they quickly identify which rooms to search, then quickly exit to a safe place, and before police respond.

Criminals often enter the homes through pet doors. They're commonly kept open for the animals to access, and the doors for even medium-sized animals are easy to squeeze through. Even those that feature locks are easy to kick in and more easily than any other door. They're usually featured on backdoors or side doors, so these burglars aren't seen by others, either. Having a pet, then, may actually increase the risk of burglary for many households.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that typical pet doors may include flexible flaps over an opening in a wall or a door to allow a pet to have access to a house. The pet normally presses against the flexible flap allowing the pet to displace the flap and exit and/or enter the house. These pet doors may further include a frame defining an opening or portal with a top-hung closure flap in the opening. Unfortunately, the flap may be very uneconomical during inclement weather. In addition, these types of pet door offer little or no security and may allow other animals or even people to have access to the home.

To prevent inclement weather penetration, some pet doors may include an overlapping of plastic material. These pet doors still operate by way of the pet having to push against the door or flap with its head in order to enter or exit the house. To guard against unwanted animals such as, stray dogs, cats or wild animals, entering a building, selective pet doors have been developed. Selective pet doors may include a latch which secures the flap against opening in one direction, and means to retract the latch in the other direction. A drawback of such pet doors is that these are relatively costly. Another drawback is that these need a source of electrical energy where there are costs and complications of using electrical energy. If battery power is used, batteries may require replacing at frequent intervals. The above selective pet doors may not be ideal for everybody.

Some pet doors may come with locking systems. Those locking systems only work against unwanted entry and exit by pets. Such ordinary latches and slats that secure a pet door may be easily kicked in by a person. There are pet doors that operate with radio-frequency locks that attach to a pet collar. They remain locked until a pet wearing the proper transmitter comes near the door. Those devices are not only easy to overcome, but they may actually put the life of the animal at risk. For instance, if a burglar entered a yard with a transmitter-wearing animal, he may simply kill the pet, remove the transmitter, then use it himself to enter the house. Accordingly, the so-called security measures may be ineffective and dangerous.

The use of pet doors is practically a given nowadays. Today's pet owners may consider these and other pet items, which were once regarded to be luxury, as ordinary items of established need. These consumers are still looking for luxury, though, according to the American Pet Product Manufacturers Association. According to this organization's own studies, the top industry trend in pet products is for new and upgraded pet items. Convenience and safety are included in the top factors for this trend, too.

Pet ownership in the U.S. is at an all-time high, and has increased 24 percent over the last 20 years. When it comes to cats, almost 40 percent of all U.S. households have a feline; that's over 45 million consumers. And for dogs, almost half of all American households—46.6 percent for almost 57 million—own a canine. Spending on products for these animals has increased, as well, and at a far faster rate. Total annual spending on pet products in the U.S. broke $60 billion in 2015. This high rate of growth in sales for the industry is rather common, as its sales have more than tripled in the last 20 years. About a quarter of these high sales (23.6 percent) are attributed to pet supplies and accessories. Not food, not veterinarian bills, not grooming fees and not the costs of new pets themselves, but supplies for use by pet owners in the care of their animals. That means that products such as leashes, food dishes—and yes, pet doors—are responsible for about $14.6 billion of these total annual sales. These items are even growing in sales faster than other pet products. For example, sales of this category of pet supplies grew roughly 4.5 percent annually in each of the last three years, while all other items and services for animal owners increased only 3.6 percent. The American Pet Products Manufacturers Association predicts this growth to continue at a viable rate, too, and to reach $67.5 billion in annual sales by 2018. “With new products and services being introduced at an increasingly rapid pace, it appears American's love affair with their pets will continue,” predicts the APPMA.

Over a third of pet-owning households may have children in the house. Quite often those children are just as small or smaller than the pets—and small enough to crawl through those same pet doors. This unwanted action may easily take place, too. Even a toddler may recognize that a pet uses that particular door, and a parent may not be able to keep an eye on each and everything a child does at all times of the day and night.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary pet door system in closed position, in accordance with an embodiment of the present invention;

FIG. 2 is an illustration of an exemplary pet door system in an open position, in accordance with an embodiment of the present invention;

FIG. 3 is a close-up view of an exemplary lock device, in accordance with an embodiment of the present invention;

FIG. 4 is a front view of an exemplary lock device, in accordance with an embodiment of the present invention;

FIG. 5 is a close-up view of an exemplary threaded hole, in accordance with an embodiment of the present invention;

FIG. 6 is an illustration of an exemplary pet door system to be installed on an existing pet door, in accordance with an embodiment of the present invention;

FIG. 7 is an illustration of an exemplary pet door system securing an existing pet door, in accordance with an embodiment of the present invention; and

FIG. 8 is an illustration of an exemplary pet door system in use, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit “about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, are generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some embodiments of the present invention and variations thereof, relate to pet door security systems. In one embodiment of the present invention, the innovative pet door security system comprises a security door that may be mountable upon existing medium-to-large sized pet doors, and which is lockable in order to prevent unwanted access to a home through such doors. The secured pet door system addresses a need due to an established record of burglary access through conventional pet doors, and may be superior in these provisions to other devices that claim to serve the same purpose. The secured pet door system may include a frame for mounting about a perimeter of a new or existing pet door, and a barred security door that may be attached to the frame by hinges. A featured deadbolt locking mechanism, controllable by, but not limited to, key, affixes within the barred security door, and mounts within the frame when secured. Bolts for mounting of the secured pet door system upon an existing pet door may be configured to utilize the bolt pattern of the existing pet door.

In other embodiments, the mounting bolt implement pattern of the secured pet door system may be designed to match existing bolt patterns of currently marketed pet doors. This may ensure easy and cost-effective installation, and even upon already-installed pet doors. In one embodiment, the mounting bolt pattern of the secured pet door system may differ from model to model of the secured pet door system, so that there are secured pet door systems that may accommodate various pet doors, all of which may have different bolt patterns. The secured pet door system is made of steel so it may provide a true security door option for pet doors, and it is designed to work with new and existing pet doors. The system may accept a deadbolt, the deadbolt may accept a key from the interior and exterior side, and the key may be keyed to match other door locks of a home. As the secured pet door system is secured to an existing pet door, the system comes with mounting bolts or screws long enough to go through the frame of the existing pet door and then fully into the bolt-accepting holes built into the interior surface side of the invention door frame. The mounting bolts of the system as well as the mounting bolt-accepting holes of the system also share the same thread pattern as the installation holes of existing pet doors. The system is a durable way to secure a pet door from intruders, and unlike products with similar intent, the system cannot be easily overcome. The system may include an anti-pry tab that is configured to prevent an intruder from prying open the deadbolt. An exterior surface of the frame is smooth, and the mounting or installation bolts are not accessible, which may prevent the mounting or installation bolts from being sheered or broken off by an intruder.

In further embodiment, the secured pet door system may securely attach to the frame of a new or existing pet door. The system may easily and simply attach to the frame of a pet door. The mounting or installation bolt implement pattern of the secured pet door system may be designed to align with a bolt pattern of pet doors. Utilizing the bolt pattern of an existing pet door to attach the secured pet door system aids in simplicity of installation. The system may provide a security gate upon the pet door to which it attaches, locks its security gate, and prevent unwanted and unapproved access to a home through the pet door to which it attaches. By preventing unwanted and unapproved access to a home, the system may prevent burglary and vandalism to the home. The system addresses a common risk incurred by homes with medium- and large-sized pet doors. Due to the fact that medium-and large-sized pet doors are of size for unwanted use and access by humans, the system prevents that unwanted access by blocking such pet doors with a lockable gate. Due to the fact that home burglaries through such medium-and large-sized pet doors are of established record, the system addresses a recognized need.

In additional embodiments, the secured pet door system may protect the properties and assets of a home to which it attaches, protects the residents of a home to which it attaches, and may provide needed protection much better than other methods. Unlike latches, panel slats, and locking mechanisms included directly on many pet doors, the metalized secured pet door system may not be kicked in or removed. Unlike pet doors with electronic locking devices, the durable and sturdy system cannot be kicked in or removed. Whereas many electronic pet doors using radio-frequency (RF) locks include transmitters for attachment to a pet collar, which leaves the pet at risk of harm by a burglar seeking access to that transmitter for his own use to enter the home, the secured pet door system protects the pets of a home from such risks. The secured pet door system aids a household from unwanted entry by other animals, as well. Whereas stray pets and small wildlife commonly approach pet-owning households in search of food, the system may eliminate the risk of such animals from entering a home to which it is attached.

In alternative embodiments, the secured pet door system may be made of various applicable materials that are of applicable strength and durability, such as but not limited to carbon steel, alloy steel, and aluminum alloy. A various number of vertical rods may be included in the security door portion of the system. The system may be made in various sizes and shapes that match sizes and shapes of pet doors to which it will attach. The mounting or installation bolt pattern of the system may vary in order to match the bolt pattern of different pet doors. The system may be made in variations that include screening, allowing a pet door to remain open for air circulation within the home, but while still preventing a pet from exiting and still protecting the home from unwanted intrusion. The system may include a separate pet door in its final packaging. The system may be made in variations in which it is permanently attached to a pet door, forming a single unit. Various locking mechanisms may be included in the system such as but not limited to deadbolt locking mechanisms, magnetic latch, electronic locking mechanisms, etc. The system may include different features to protect its durability and/or appearance, including but not limited to rust-resistant coatings and ultraviolet (UV) light-resistant coatings. The system may be produced in various colors and may also bear various designs, emblems and/or logos, which may or may not be of registered trademark and/or copyright status.

In some embodiments, the secured pet door system may be made of carbon steel in a hollow, approximately one-inch (1″), square-rod format. The interior dimensions of the base frame portion of the system measure approximately twelve and one-half inches in length by nineteen and three-quarter inches in height (12½″×19¾″). Threaded apertures for mounting of this frame upon an exterior frame of an existing pet door are evenly distributed in the same bolt pattern as the existing pet door, and threaded mounting or installation bolts for application of the system frame are included in final packaging. By utilizing the existing bolt pattern and mounting or installation bolt size of the pet door, the system is easy to install right on to the pet door. The exterior dimensions of the door measure approximately twelve and one-half inches in length by nineteen and three-quarter inches in height (12½″×19¾″). This door includes about two (2) vertical rods in its interior plane, and the rods are evenly distributed at a distance of approximately four inches (4″) from each other and from each exterior portion of the door. More or less two (2) hinges attach on one (1) exterior vertical plane of this door, and for attachment of said door to the base frame. On the vertical plane of the door that is opposite of that hosting the hinges is a deadbolt locking mechanism, operated by key. The deadbolt extends from the locking mechanism horizontally for approximately one inch (1″) in length. The locking mechanism is mounted on a plate disposed proximately between the exterior vertical rod and its nearest interior vertical rod. An aperture for acceptance and insertion of the deadbolt may be included in both sides of the plate, on the exterior vertical plane of the door and the frame of the structure.

In use, a user may mount the secured pet door system by applying its mounting or installation bolts through the bolt pattern of an existing pet door of matching size. When the existing pet door is not in need of access by the pet, the user may lock the deadbolt of the system with included key. During this locked phase, the secured pet door system may ensure security to the household by preventing unwanted access by others.

In some other embodiments, the pet door security system may provide a needed improvement to existing pet doors, and may provide security to homes. The secured pet door system is a durable metal security door that may be easily attached to an existing pet door of medium-to-large sizes to prevent unwanted entry and/or exit. The deadbolt of the door portion may be locked. From that point forward the pet door to which it attaches may only be opened when the owner desires. Existing pet doors may be an easy access points for burglars, after all, especially when the lifestyles of pet-owning households make it evident when such access is best. Existing pet doors may also be easy access for other animals and children can use pet doors, too. The innovative pet door system may prevent all of these unwanted accesses from occurring, thus satisfying multiple needs.

In featured embodiments, the secured pet door system may comprise a base frame attachable to the frame of a new or existing pet door, a metal gate door attachable to the base frame, apertures about frame for mounting upon the exterior frame of a pet door, vertical rods evenly distributed in the gate door, hinges for attachment of gate door to the frame, and a deadbolt locking system. The system is made of carbon steel in hollow, square-rod format.

In beneficial embodiments, the secured pet door system may:

a) Securely attach to the frame of a pet door.
b) Provide a security gate to pet doors.
c) Provide a lockable security gate.
d) Provide needed security improvements to homes with pets.
e) Prevent unwanted access to homes through pet doors.
f) Address a common risk to homes with pet doors.
g) Prevent burglaries and vandalism to homes with pet doors.
h) Protect the property and possessions of users.
i) Protect residents of using households.
j) Work better than other pet door security measures.
k) Work better than latches, slats and locks featured on many types of pet doors.
L) Work better than pet doors that feature radio frequency locks.
m) Eliminate the risks presented to animals by use of pet doors with radio frequency locks.
n) Prevent pet door use by small children in a using home.
o) Join a rapidly growing product market.
p) Join the top-selling trends of this product market.
q) Appeal to a very large and growing consumer group.

The present invention will now be described in detail with reference to embodiments thereof as illustrated in the accompanying drawings.

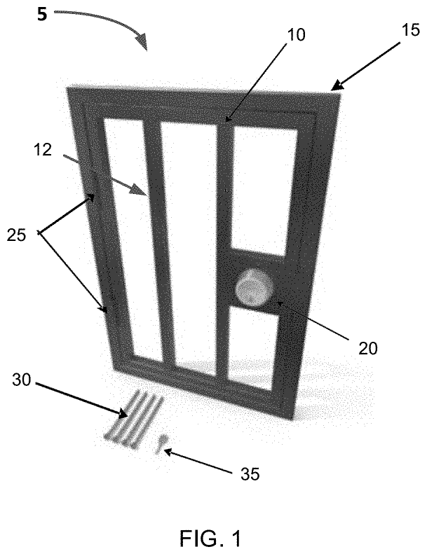

FIG. 1 is an illustration of an exemplary pet door security system in closed position, in accordance with an embodiment of the present invention. In the present embodiment shown, pet door security system 5 includes door portion 10, door frame portion 15, pair of hinges 25, deadbolt lock device 20, more or less four (4) vertical rod/bar segments 12 just about evenly distributed in door portion 10, mounting or installation bolt implements 30, and key implement 35 for deadbolt lock device 20. Mounting or installation bolt implements 30 are configured to significantly engage roughly four (4) corners of an existing pet door, the system is mounted to. The mounting or installation bolt implements may have the same diameter and thread configuration of an existing pet door. In some embodiments, door portion 10 may include an appreciably durable metal security door that may be easily attached to an existing pet door. Door portion 10 may further include, but not limited to, fiberglass insect screen, aluminum insect screen, or glass cover disposed, to all intents and purposes, in between considerably vertical rod segments 12 for added protection against environmental elements, stray animals/pets, and/or intruders. In further embodiments, pet door security system 5 is made of, but not limited to, carbon steel in hollow, square-rod format. In other embodiments, pet door security system 5 may be made of various applicable materials that are of applicable strength and durability, such as but not limited to carbon steel, alloy steel, and aluminum alloy. A various number including but not limited to two through ten (2-10) of vertical rod segments 12 may be included in the security door portion of the system. The system may be made in various sizes and shapes that match sizes and shapes of existing pet doors to which it will attach. The system may be made in variations that include screening, allowing a pet door to remain open for air circulation within the home, but while still preventing a pet from exiting and still protecting the home from unwanted intrusion.

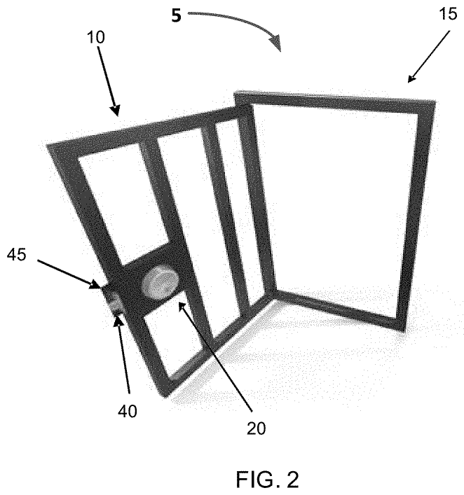

FIG. 2 is an illustration of an exemplary pet door security system 5 in open position, in accordance with an embodiment of the present invention. In the present embodiment shown, pet door system 5 includes door 10, door frame 15, deadbolt lock 20, bolt 40 of deadbolt lock 20, and anti-pry tab 45. Key 35 (shown in FIG. 1) may be accepted from both sides of deadbolt lock 20. In an embodiment, the pet door security system may be mountable upon existing medium-to-large sized pet doors, and which is lockable in order to prevent unwanted access to a home through such doors. The pet door security system addresses a need due to an established record of burglary access through conventional pet doors, and may be superior in these provisions to other devices that claim to serve the same purpose. The door frame is configured to be operable for mounting about a perimeter of an existing pet door, and a barred security door that may be attached to the door frame by hinges. A featured deadbolt locking mechanism, controllable by, but not limited to, key 35, affixes within the barred security door, and mounts within the door frame when secured. Mounting or installation bolt implements 30 for mounting of the pet door security system upon a new or existing pet door may be configured to utilize a bolt pattern of the new or existing pet door.

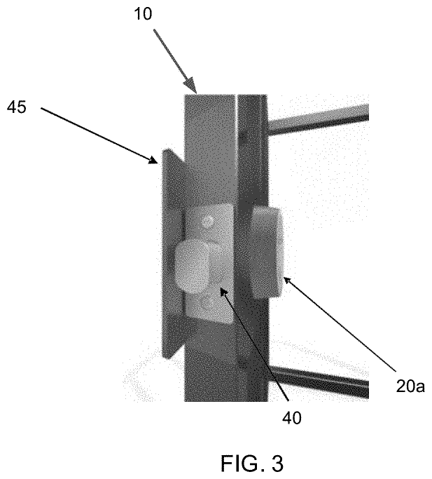

FIG. 3 is a close-up view of an exemplary locking device, in accordance with an embodiment of the present invention. In the present embodiment shown, pet door security system 5 includes a door 10, interior side portion 20a of deadbolt lock 20, bolt 40 of deadbolt lock 20, and an anti-pry tab 45. Anti-pry tab 45 is configured to, for the most part, prevent an intruder from prying open the deadbolt lock from the exterior of the pet door security system.

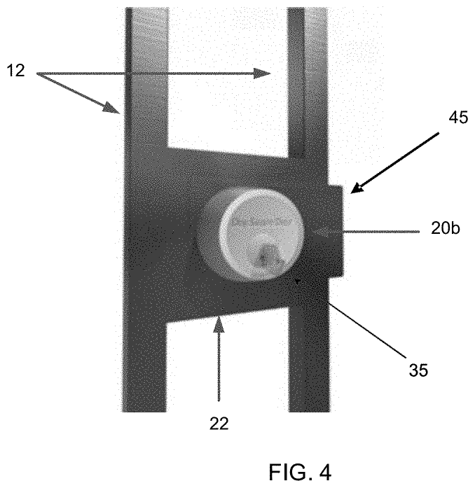

FIG. 4 is a front view of an exemplary locking mechanism, in accordance with an embodiment of the present invention. In the present embodiment shown, pet door security system 5 includes vertical rod/bar segments 12, exterior side 20b of deadbolt lock 20, key 35, and an anti-pry tab 45. Anti-pry tab 45 is configured to, on the whole, prevent an intruder from prying open deadbolt lock 20 from the exterior of pet door security system 5. Locking mechanism mounting plate 22 may be supported by two vertical rod/bar segments 12 which, in turn, provides support for deadbolt lock 20. In alternative embodiments, the locking mechanism may include but not limited to, key locks, warded locks, lever locks, pin tumbler locks, cam locks, rim/mortise locks, rim latch locks, key in knob cylinders, electronic locking devices, etc. The electronic locking devices may include wired or wireless receivers for receiving control signals and/or transmitters for sending status signals. The electronic locking devices may be operated by, but not limited to, remote control devices programmed with security features, online apps programmed with secured access, etc., for sending control signals such as but not limited to lock, unlock, request for status signals, sound an alarm, etc. The electronic locking devices may further include a power supply for providing power such as rechargeable batteries, solar cells, etc.

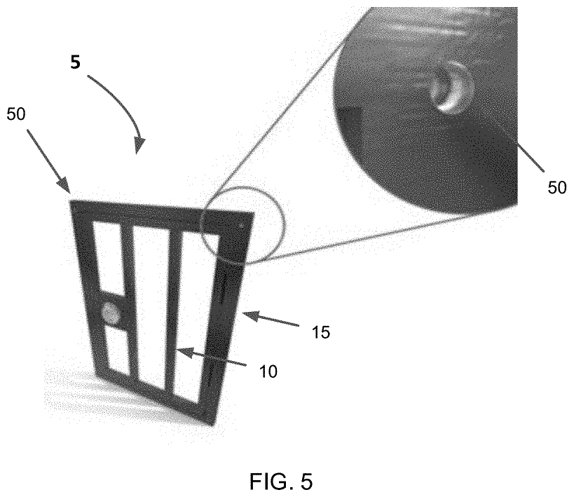

FIG. 5 is a close-up view of an exemplary threaded hole, in accordance with an embodiment of the present invention. In the present embodiment shown, pet door security system 5 includes bolt accepting hole 50 disposed on an interior side of door frame portion 15. The bolt accepting hole 50 comprises a threaded hole/aperture that is configured to accept mounting or installation bolts 30 to hold the pet door system in place. The bolt pattern of the pet door security system may vary in order to match the bolt pattern of different pet doors. There are at least approximately four (4) threaded holes 50 in a more or less exact alignment as four (4) mounting holes of the new or existing pet door the system is configured to fasten to, and to provide security. The threaded holes/apertures don't go all the way through the outer surface of door frame portion 15. This makes the mounting or installation bolt implements non-accessible from the outside, so they can't be cut or broken off by an intruder. In some embodiments, bolt accepting hole 50 for mounting of door frame portion 10 upon an exterior frame of a new or existing pet door are evenly distributed in the same bolt pattern as the new or existing pet door, and threaded mounting or installation bolts 30 for application of the system door frame may be included in final packaging. By utilizing the existing bolt pattern and bolt size of pet doors, pet door security system 5 is easy to install right on to the pet door.

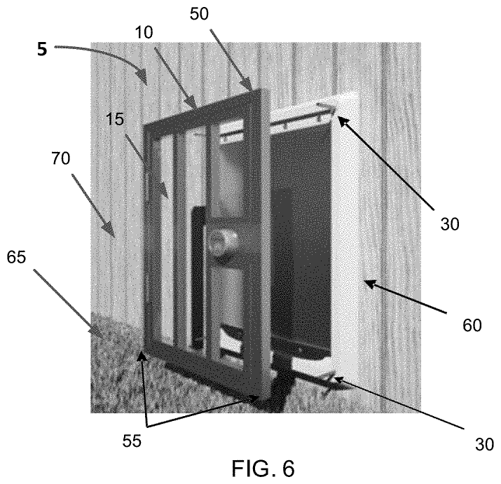

FIG. 6 is an illustration of an exemplary pet door security system 5 to be installed on a new or existing pet door, in accordance with an embodiment of the present invention. In the present embodiment shown, pet door security system 5 may easily and simply attach to a frame of an existing pet door 60, to a great extent, provide security for the existing pet door 60. The existing pet door is installed against a building exterior wall 70 at approximately ground level 65. The building may include, but not limited to, a house, apartment, condominium, school, store, office, factory, or any living space that needs protected. Pet door security system 5 is installed on to existing pet door 60 with mounting or installation bolts 30 installed and protrudes out in four corners of the existing pet door 65. Pet door security system 5 includes door 10, door frame 15, and threaded hole 50. Threaded hole is engaged with mounting or installation bolts 30 in the installation. The bolt pattern of the system may vary in order to match the bolt pattern of different pet doors. Exterior surface 55 is flushed and smooth. Mounting or installation bolts 30 do not protrude out of the door frame and the mounting or installation bolts are not accessible from the outside, so they can't be cut or broken off by an intruder. The bolt pattern of the pet door security system 5 may be designed to align with a bolt pattern of new or existing pet doors. Utilizing the bolt pattern of the existing pet door to attach pet door system 5, aids in simplicity of installation. The pet door security system 5 may then provide a security gate upon an existing pet door to which it attaches, locks its security gate, and prevent unwanted and unapproved access to a home through the existing pet door to which it attaches. By preventing unwanted and unapproved access to a building/home, pet door security system 5 may prevent burglary and vandalism to the building/home. The system addresses a common risk incurred by homes with medium-and large-sized pet doors. Due to the fact that medium-and large-sized pet doors are of size for unwanted use and access by humans, pet door security system 5 prevents that unwanted access by blocking such existing pet doors 60 with a lockable gate. Due to the fact that home burglaries through such medium-and large-sized pet doors are of established record, the system addresses a recognized need. In alternative embodiments, a new or existing pet door may be installed on a door of the building/home.

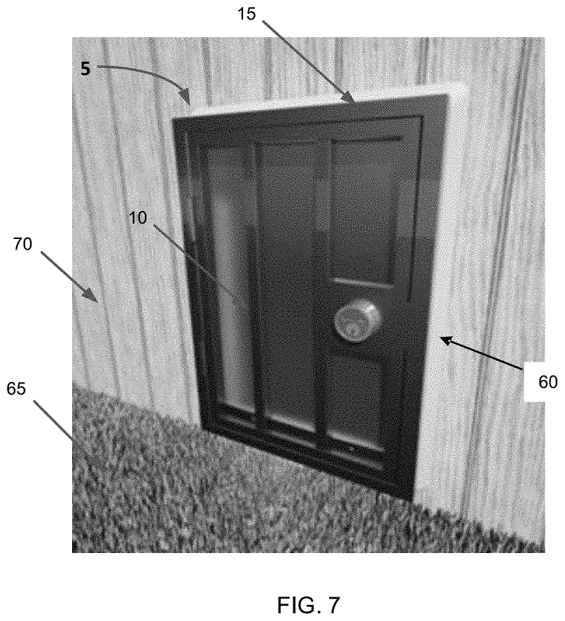

FIG. 7 is an illustration of an exemplary pet door system securing a new or existing pet door, in accordance with an embodiment of the present invention. In the present embodiment shown, the pet door security system 5 is secured in place upon a new or existing pet door 60. The pet door security system 5 is closed and locked forming a single unit. In this case, the pet door security system 5 may protect the properties and assets of a home to which it attaches, protect the residents of a home to which it attaches, and may provide needed protection much better than other methods. Unlike latches, panel slats, and locking mechanisms included directly on many existing pet doors, the metalized pet door system may not be kicked in or removed. Unlike existing pet doors with electronic locking devices, the durable and sturdy pet door system cannot be kicked in or removed.

In some other embodiments, the pet door security system 5 may provide a needed improvement to new or existing pet doors 60, and may provide security to homes. The secured pet door system 5 is a durable metal security door that may be easily attached to a new or existing pet door of medium-to-large sizes to prevent unwanted entry and/or exit. The deadbolt of the door portion may be locked. From that point forward the existing pet door 60 to which it attaches may only be opened when the owner desires. Existing pet doors 60 may be an easy access points for burglars, after all, especially when the lifestyles of pet-owning households make it evident when such access is best. Existing pet doors 60 may also be easy access for other animals and critters, and children can use pet doors, too. The innovative pet door security system may prevent all of these unwanted accesses from occurring, thus satisfying multiple needs.

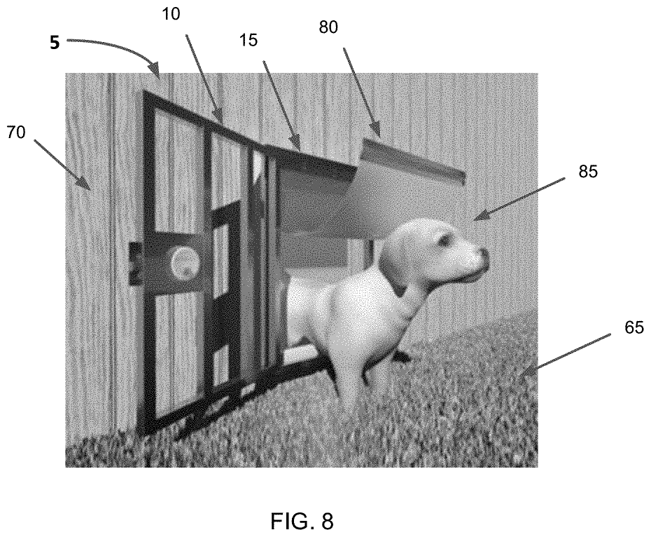

FIG. 8 is an illustration of an exemplary pet door security system 5 in use, in accordance with an embodiment of the present invention. In the present embodiment shown, a pet door security system including open door 10, where door frame 15 is secured in place upon an existing pet door with flap 80 and in use by pet dog 85. In some embodiments, secured pet door system 5 may be made of carbon steel in a hollow, approximately one-inch (1″), square-rod format. The interior dimensions of the base frame portion of the system measure approximately twelve and one-half inches in length by nineteen and three-quarter inches in height (12½″×19¾″). Threaded apertures for mounting of this frame upon an exterior frame of a new or existing pet door are evenly distributed in the same bolt pattern as the new or existing pet door, and threaded mounting or installation bolts for application of the system frame are included in final packaging. By utilizing the existing bolt pattern and bolt size of the pet door, the system is easy to install right on to the pet door. The exterior dimensions of the door measure approximately twelve and one-half inches in length by nineteen and three-quarter inches in height (12½″×19¾″). This door includes about two (2) vertical rods in its interior plane, and the rods are evenly distributed at a distance of approximately four inches (4″) from each other and from each exterior portion of the door. More or less two (2) hinges attach on one (1) exterior vertical plane of this door, and for attachment of said door to the base frame. On the vertical plane of the door that is opposite of that hosting the hinges is a deadbolt locking mechanism, operated by key. The deadbolt extends from the locking mechanism horizontally for approximately one inch (1″) in length. This locking mechanism is mounted proximately between the exterior vertical rod and its nearest interior vertical rod. An aperture for acceptance and insertion of the deadbolt may be included in both the exterior vertical plane of the door and the frame of the structure.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing pet door security system according to the present invention will be apparent to those skilled in the art. Various aspects of the invention have been described above by way of illustration, and the specific embodiments disclosed are not intended to limit the invention to the particular forms disclosed. The particular implementation of the pet door security system may vary depending upon the particular context or application. By way of example, and not limitation, the pet door security system described in the foregoing were principally directed to providing security to existing pet door implementations; however, similar techniques may instead be applied to outer doors of a building, home, office, or any living space that may need security, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A system comprising:
a security door portion, said security door portion is configured to provide secured access to a new or existing pet door;
a door frame portion, said door frame portion is configured to mount about a perimeter of said new or existing pet door;
a hinge implement, said hinge implement comprises at least two or more hinges, said two or more hinges are configured to engage said door portion and door frame portion;
a locking mechanism, said locking mechanism is configured to selectively prevent unwanted access through said security door portion;
a locking mechanism mounting plate implement, wherein said locking mechanism mounting plate implement is configured to receive said locking mechanism;
an installation bolt accepting hole part disposed on an interior side of said door frame portion, said installation bolt accepting hole part is configured to be operable for mounting said door frame portion to said new or existing pet door; and
an anti-pry tab, said anti-pry tab is configured to prevent an intruder from prying open said locking mechanism.

2. The system of claim 1, further comprising at least four installation bolt implements, each installation bolt implement being disposed on a bolt pattern of the new or existing pet door.

3. The system of claim 2, in which said installation bolt accepting hole part comprises at least four bolt accepting holes, each bolt accepting hole is configured to correspond to said bolt pattern of the new or existing pet door, wherein each bolt accepting hole is configured to receive each of said bolt implement.

4. The system of claim 3, wherein an exterior surface of said door frame portion is sealed smooth to prevent access to said at least four installation bolt implements.

5. The system of claim 4, wherein said security door portion comprises more or less equally spaced vertical bars or rods, in which said vertical rods include at least four or more vertical rods distributed in said security door portion.

6. The system of claim 5, in which said security door portion further comprises of carbon steel in hollow, square-rod format.

7. The system of claim 6, wherein said locking mechanism comprises a deadbolt lock device.

8. The system of claim 7, wherein said locking mechanism further comprises a key for operating said deadbolt lock device.

9. The system of claim 5, in which said door frame portion comprises of carbon steel in hollow, square-rod format.

10. The system of claim 9, wherein said locking mechanism comprises an electronic lock device that is configured to be operable with remote control devices programmed with security features for said electronic lock device or online apps with secured access.

11. The system of claim 10, wherein said electronic lock device comprises a wired or wireless receiver for receiving control signals from said remote control device or online app.

12. A system comprising:
means for providing secured access to a new or existing pet door;
means for mounting said secured access providing means about a perimeter of said new or existing pet door;
means for engaging said secured access mounting means and said secured access providing means;
means for selectively preventing unwanted access through said secured access providing means;
means for receiving said unwanted access preventing means;
means for installing said mounting means to said new or existing pet door;
means for preventing an intruder from prying open said unwanted access preventing means; and
means for operating said unwanted access preventing means.

13. A system consisting of:
a security door portion, said security door portion is configured to provide secured access to a new or existing pet door;
a door frame portion, said door frame portion is configured to mount about a perimeter of said new or existing pet door;
a hinge implement, said hinge implement comprises at least two or more hinges, said two or more hinges are configured to engage said door portion and door frame portion;
a locking mechanism, said locking mechanism is configured to selectively prevent unwanted access through said security door portion;
a locking mechanism mounting plate implement, wherein said locking mechanism mounting plate implement is configured to receive said locking mechanism;
a plurality of installation bolt implements, said plurality of installation bolt implements comprises least four installation bolt implements, each installation bolt implement being disposed on a bolt pattern of said new or existing pet door.
a plurality of installation bolt accepting hole parts disposed on an interior side of said door frame portion, said plurality of installation bolt accepting hole parts are configured to be operable for mounting said door frame portion to said new or existing pet door; and
an anti-pry tab, said anti-pry tab is configured to prevent an intruder from prying open said locking mechanism.

14. The system of claim 13, in which said plurality of installation bolt accepting hole parts comprises at least four bolt accepting hole parts, wherein each bolt accepting hole part is configured to correspond to said bolt pattern of said new or existing pet door, and wherein each bolt accepting hole part is configured to receive each of said corresponding bolt implement.

15. The system of claim 14, wherein an exterior surface of said door frame portion is sealed smooth to prevent unwarranted access to said at least four installation bolt implements.

16. The system of claim 15, wherein said security door portion comprises more or less equally spaced vertical bars or rods, in which said vertical rods include at least four or more vertical rods distributed in said security door portion.

17. The system of claim 16, in which said security door portion further comprises of carbon steel in hollow, square-rod format.

18. The system of claim 17, wherein said locking mechanism comprises a deadbolt lock device and a key for operating said deadbolt lock device.

19. The system of claim 17, wherein said locking mechanism comprises an electronic lock device that is configured to be operable with remote control devices programmed with security features for said electronic lock device or online apps with secured access.

20. The system of claim 19, wherein said electronic lock device comprises a wired or wireless receiver for receiving control signals from said remote control device or online app.
